(19) United States
(12) Patent Application Publication
(10) Pub. No.: US 2009/0244160 A1
(43) Pub. Date: Oct. 1, 2009

(54) PRINTER

(75) Inventor: Yuji NAKAGAKI, Chiba (JP)

Correspondence Address: KRATZ, QUINTOS & HANSON, LLP, 1420 K Street, N.W., Suite 400, WASHINGTON, DC, 20005, US

(73) Assignee: SEIKO PRECISION INC., Narashino-shi (JP)

(21) Appl. No.: 12/480,138

(22) Filed: Jun. 8, 2009

Related U.S. Application Data
(63) Continuation of application No. PCT/JP2007/072939, filed on Nov. 28, 2007.

(30) Foreign Application Priority Data
Dec. 11, 2006 (JP) 2006-333228

(51) Int. Cl. B41J 29/38; B41J 2/01

(52) U.S. Cl. 347/16; 347/102

(57) ABSTRACT

A printer includes: a print head for ejecting ink on a print medium; a drying portion for blowing hot air to the printed print medium so as to expedite drying of the ink applied on the printed print medium, the drying portion including a blowing amount changing portion changeable a blowing amount of the hot air blown to the print medium; a detecting portion for detecting a feeding speed of the print medium; and a controller unit for controlling the blowing amount changing portion in response to the feeding speed of the print medium detected by the detecting portion.

### CROSS-REFERENCE TO RELATED APPLICATION

This application is a continuation of and claims priority to International Patent Application No. PCT/JP2007/072939 filed on Nov. 28, 2007, which claims priority to Japanese Patent Application No. 2006-333228 filed on Dec. 11, 2006, subject matter of these patent documents is incorporated by reference herein in its entirety.

### BACKGROUND OF THE INVENTION

1. Field of the Invention

The present invention relates to a printer.

2. Description of the Related Art

Conventionally, there has been known a printer which includes a drying heater. The drying heater blows hot air to a print medium printed so as to dry ink applied on the print medium (see Japanese patent application publication No. 2005-241263). Such a drying heater is arranged to blow hot air to the print medium in the partway of a career of the print medium. The drying heater promotes to reduce a drying period of the ink.

In such a printer, there is a case where a feeding speed of the print medium is changed. For example, in a case where the printer mentioned above is built into a production line, a feeding speed of the print medium is set in accordance with the feeding speed in a production line. Thus, when the feeding speed of the print medium is changed by a certain reason of the production line, the feeding speed of the print medium in the printer is also changed. For example, when the production line is slowed down or stopped by a trouble with equipment thereof, the feed of the print medium is also slowed down or stopped. In or in a case where the amount of production is more increased than usual, the production line speed is made faster and the feed of the print medium is also made faster.

For example, in a case where the feed of the print medium is stopped, the drying heater blows hot air to a certain portion of the print medium over a long time. When hot air is blown to the certain portion of the print medium with over a long time, the print medium may be heated excessively, so that the print medium will be wrinkled and extended. This degrades the quality of the print medium. Therefore, in order to prevent such a trouble and prevent the extension of the print medium even when the feed of the print medium is stopped, the temperature of hot air of the drying heater is set to be low. However, in a case where the temperature of hot air is set to be low, for example, when the feeding speed of the print medium is increased, the drying of the ink applied on the print medium may be insufficient. Also, this may produce smear caused by transfer.

Further, in such a printer, a fan is arranged directly above the drying heater. By rotating the fan, hot air heated by the drying heater is blown to the print medium. In this case, the fan is not excessively heated because the high temperature air does not reach the fan while the fan is rotating. However, when the rotation of the fan is stopped, the heated air of the drying heater reaches the fan. This may lead to the fan heated enough to brake a mechanical part such as a bearing.

For example, in a case where the printer is turned off at the end of work and the drying heater and the fan are immediately turned off, the drying heater keeps its heating state during a certain time. This causes the air to be heated, and the fan is excessively heated by the heated air. In this manner, the mechanism of the fan may be broken.

For this reason, at the end of work, the rotation of the fan is kept after the drying heater is turned off. The fan is turned off after the temperature of the drying heater is cooled down to a certain one.

Incidentally, the print medium and the drying heater are provided as close to each other as possible so as to improve the efficiency of the drying. The hot air heated by the drying heater is exhausted from a clearance between the print medium and the drying heater. This structure may allow the space between the drying heater and the print medium to be maintained at high temperatures with ease. However, when cooling is needed, there is a drawback in that the temperature is hardly reduced, since the high temperature air is not immediately exhausted.

For this drawback, at the end of work, it is necessary to maintain the rotation of the fan for a long time even after the drying heater is turned off, in order to decrease the temperature of the drying heater. Then, it is necessary to turn off the fan after the temperature of the fan is reduced to a certain temperature. Consequently, the period from the end of work to the power-off of the whole printer becomes longer, thereby degrading the workability.

### SUMMARY OF THE INVENTION

It is therefore an object of the present invention to provided a printer in which a quality of a print medium can be maintained independently of a change in feeding speed of the print medium and in which a drying capability of ink is improved, and to provided a printer in which the workability is improved.

According to an aspect of the present invention, there is provided a printer including: a print head for ejecting ink on a print medium; a drying portion for blowing hot air to the printed print medium so as to expedite drying of the ink applied on the printed print medium, the drying portion including a blowing amount changing portion changeable a blowing amount of the hot air blown to the print medium; a detecting portion for detecting a feeding speed of the print medium; and a controller unit for controlling the blowing amount changing portion in response to the feeding speed of the print medium detected by the detecting portion.

With such a configuration, since the blowing amount changing portion can be controlled in response to the feeding speed of the print medium, the temperature of hot air is set high beforehand and the blowing amount is changed, even when the feeding speed of the print medium is reduced by any cause, the print medium is prevented from being wrinkled and extended, and the drying property of the ink is improved.

### BRIEF DESCRIPTION OF THE DRAWINGS

Preferred embodiments of the present invention will be described in detail with reference to the following drawings, wherein:

FIG. 1 is an explanatory view in which a printer according to the present embodiment of the present invention is employed in packaging equipment;

FIG. 2 is a functional block diagram showing a configuration of the packaging equipment;

FIG. 3 is a perspective view of the external appearance of the drying heater;

FIG. 4A is a plan view of the drying heater, FIG. 4B is a front view of the drying heater, FIG. 4C is a bottom view of the drying heater, and the FIG. 4D is a right side view of the drying heater;

FIG. 5 is a cross-sectional view taken along A-A line in FIG. 4B, in a state in which blow hole is fully opened;

FIG. 6 is a cross-sectional view taken along A-A line in FIG. 4B, in a state in which the blow hole is fully closed;

FIG. 7 is a cross-sectional view taken along B-B line in FIG. 4B, in the state in which the blow hole is fully opened;

FIG. 8 is a cross-sectional view taken along B-B line in FIG. 4B, in the state in which the blow hole is fully closed;

FIG. 9 is a cross-sectional view taken along C-C line in FIG. 4B, in the state in which the blow hole is fully opened;

FIG. 10 is a cross-sectional view taken along C-C line in FIG. 4B, in the state in which the blow hole is fully closed;

FIG. 11A illustrates a table of product data, FIG. 11B illustrates a graph representing a relationship between the opening rate of the blow hole and the feeding speed of the print medium, and FIG. 11C illustrates an example of the blowing amount setting data; and

FIG. 12 is an explanatory view of the case where something is printed on a box by using a printer.

### DESCRIPTION OF THE PREFERRED EMBODIMENTS

A description will now be given, with reference to the accompanying drawings, embodiments of the present invention.

### First Embodiment

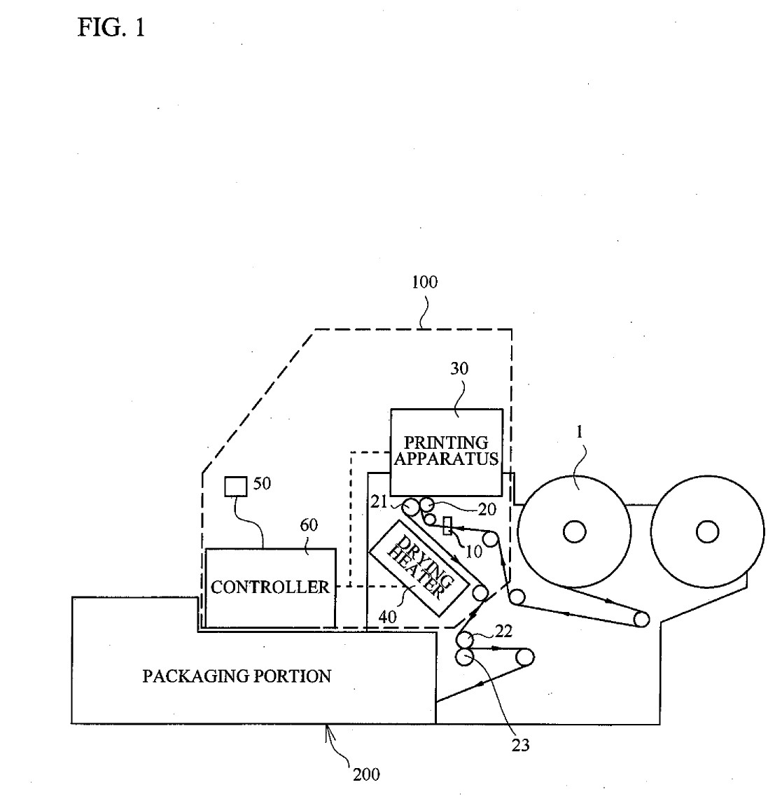

FIG. 1 is an explanatory view in which a printer according to the present embodiment of the present invention is employed in packaging equipment.

Referring to FIG. 1, the packaging equipment includes a printer portion 100 and a packaging portion 200.

The printer portion 100 prints on a packaging medium, as a print medium, for packaging a packaged material (product). For example, a package film 1 as the print medium is printed with a bar-code, a packaging date, or a expiration date, so as to correspond to the packaged product.

Subsequently, the package film 1 printed by the printer portion 100 packages a predetermined product with the packaging portion 200. The packaged product is, e.g., something to eat.

The printer portion 100 includes a timing sensor 10, an encoder 20, a printing apparatus 30, a drying heater 40 (drying portion), a bar-code reader 50, and a controller 60.

As illustrated in FIG. 1, the package film 1 packaging the product is rolled, and extended by the packaging portion 200. The package film 1 is changed in a feeding direction by each roller, and is fed to the packaging portion 200 on a feeding path. Additionally, a predetermined mark (such as a registration mark) is marked at a cut position corresponding to a size of the product packaged. Moreover, all rollers employed in the printer portion 100 are following rollers, and do not have a drive source.

The timing sensor 10 is arranged on the feeding path. The timing sensor 10 measures the print timing on the package film 1 by reading the mark on the package film 1. Additionally, in a case where the mark mentioned above is not marked on the package film 1, a timing signal is created on the basis of a cut size preliminarily set in the packaging portion 200. By transferring this timing signal to the controller 60, the mark mentioned above may be used as a substitution.

The encoder 20 detects the feeding speed of the package film 1 passing through the feeding path. That is, the encoder 20 detects the speed of the package film 1 when the package film 1 passes through the position to which hot air is blown by the drying heater 40.

The encoder 20 is arranged to face a print roller 21. The package film 1 is fed between the encoder 20 and the print roller 21. The encoder 20 is constantly in pressure contact with the print roller 21 by a spring, not shown. When the package film passes between the encoder 20 and the print roller 21, the print roller 21 is rotated by a frictional force generated between the print roller 21 and the package film 1, since the package film is urged to the print roller 21 by the encoder 20. On the other hand, the encoder 20 also rotates in response to the package film. As mentioned heretofore, the feeding speed of the package film 1 can be detected.

The printing apparatus 30 is provided for printing on the package film 1 and includes a print head (not shown) that ejects the ink to the package film 1. The package film 1 is printed with the packaging date, or the expiration date mentioned above, name of the product, primary material, usage, vendor name, manufacturer name, and bar-code corresponding to a product packaged by the package film 1. Further, the matter printed by the printing apparatus 30 is not limited to the above ones.

The drying heater 40 is arranged at a downstream side of the printing apparatus 30, and faces the package film 1. The drying heater 40 blows hot air to the printed package film 1 so as to expedite drying of the ink applied on the package film 1. Moreover, the drying heater 40 is capable of changing the amount of hot air blew to the package film 1 in response to an instruction from the controller 60. The description will be given in detail below.

The packaging portion 200 is arranged at a downstream side of the printer portion 100, and includes a mechanism for packaging a predetermined product with the package film 1. After the product is packaged with the package film 1, the package film 1 is cut at a given position thereof. A driving roller 22 controlled by the packaging portion 200 is arranged at the proximity of an inlet of the packaging portion 200. A following roller 23 is arranged to face the driving roller 22. The following roller 23 is constantly in pressure contact with the driving roller 22 by a spring not shown. When the following roller 23 rotates with the package film sandwiched between the driving roller 22 and the following roller 23, the package film is followed in response to the rotation of the driving roller, because the package film is in pressure contact with the driving roller 22. In this manner, the package film is fed into the packaging portion 200. Additionally, a detailed structure of the packaging portion 200 is omitted in FIG. 1.

The bar-code reader 50 is connected with a controller unit 64 via a communication cable. A user can carry the bar-code reader 50 as far as the length of the communication cable is allowed. In addition, the bar-code reader 50 is used for a user to read the bar-code printed on the package film 1. The description will be given in detail later.

The controller 60 is capable of communicating with the timing sensor 10, the encoder 20, the drying heater 40 and the like, and controls the operation of the printer portion 100.

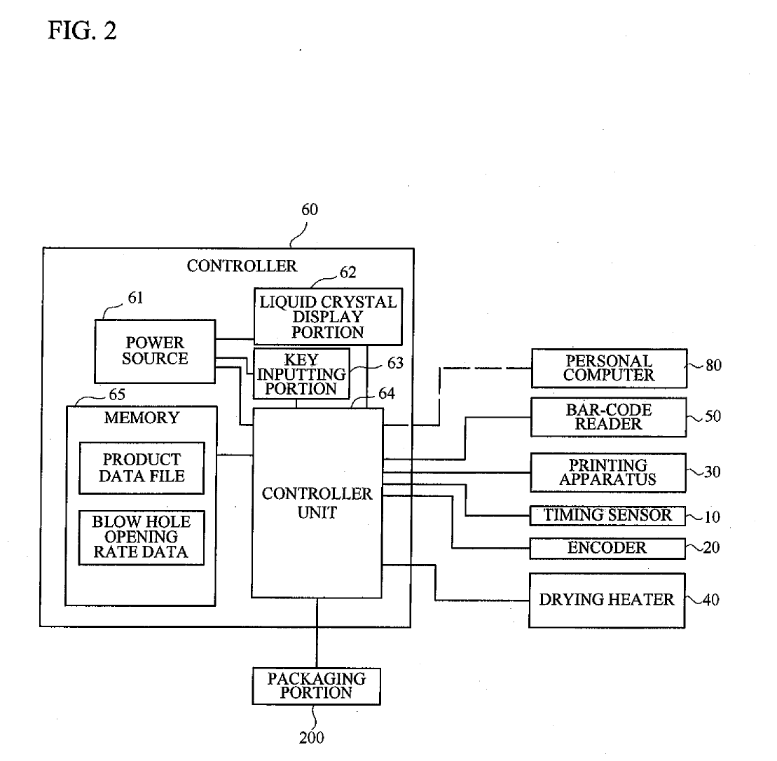

FIG. 2 is a functional block view of the printer portion 100.

The controller 60 includes a power source 61, a liquid crystal display portion 62, a key inputting portion 63, the controller unit 64, and a memory 65.

The power source 61 is provided for supplying the printer portion 100 with power.

The liquid crystal display portion 62 and the key inputting portion 63 serve as a user interface for identifying data of a product packaged by the package film 1. Further, when the bar-code corresponding to the product is already printed on the package film 1, a user causes the controller unit 64 to read information for identifying the product to be packaged, by using the bar-code reader 50. The controller unit 64 reads the data corresponding to the product on the basis of the information included in the bar-code. In this manner, the product may be identified. Additionally, the barcode may be read anywhere on the feeding path as far as the bar-code reader 50 can be carried. The product data read out is the data, set for each product, to be printed on the package film 1. The controller unit 64 outputs certain instructions to each device on the basis of the product data that has been read out.

The controller unit 64 includes a CPU (Central Processing Unit), a ROM (Read Only Memory), and a RAM (Random Access Memory). The controller unit 64 gives an instruction each apparatus. Moreover, the controller unit 64 controls the blowing amount of hot air blown to the package film 1 from the drying heater 40, in response to a feeding speed, detected by the encoder 20, of the package film 1 when the package film 1 is fed through the position where hot air is blown. Specifically, the product data, which is associated with the product to be packaged by the package film 1, and the blowing amount setting data, which is associated with each product and defined by the relationship between the feeding speed of the package film 1 and the blow amount of hot air blown from the drying heater 40, are read out from the memory 65, so that the blowing amount of the drying heater 40 is controlled. The product data, the blowing amount setting data, and the drying heater 40 will be described later.

The drying heater 40 has a stepping motor 400 which rotates on the basis of the instruction given from the controller unit 64.

The memory 65 stores the product data mentioned above and the blowing amount setting data.

A personal computer 80 is provided for sending the controller 60 the product data and the blowing amount setting data created by a user with the personal computer 80. The product data and the blowing amount setting data sent to the controller 60 are stored in the memory 65 via the controller unit 64.

Also, the controller unit 64 is capable of communicating with the packaging portion 200.

Next, a description will be given of the external appearance of the drying heater in detail.

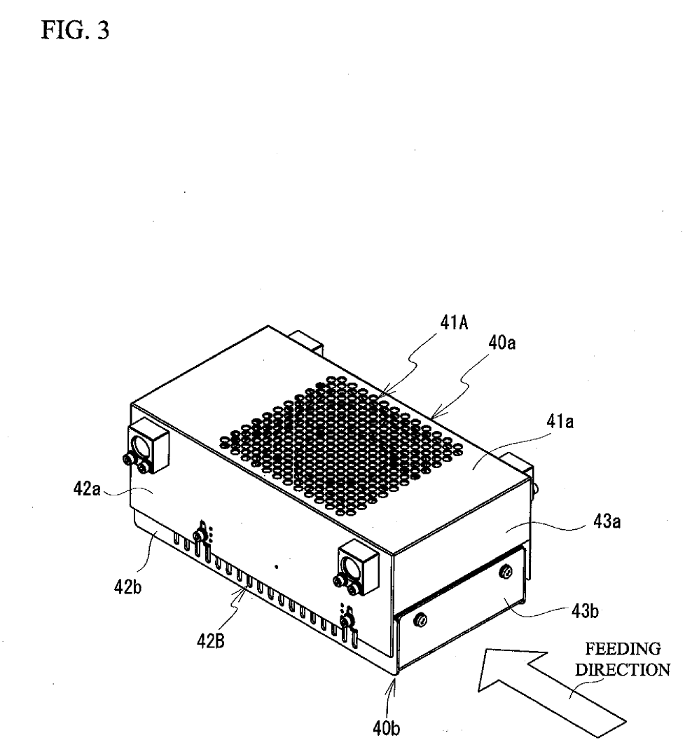

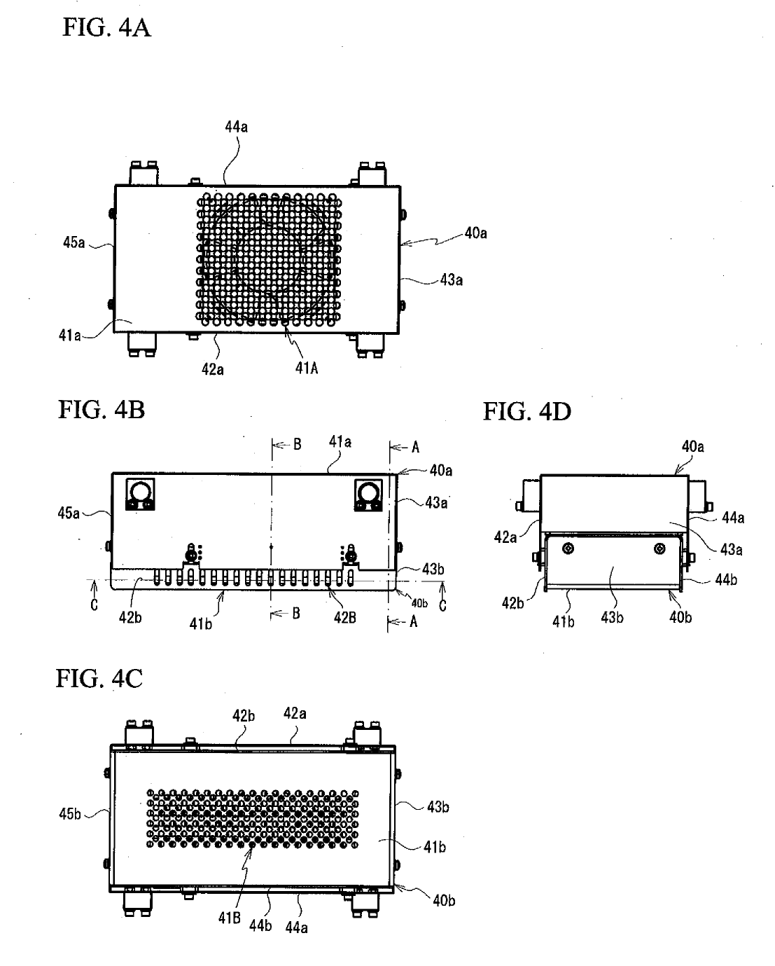

FIG. 3 is a perspective view of the external appearance of the drying heater 40. FIG. 4A is a plan view of the drying heater 40, FIG. 4B is a front view of the drying heater 40, FIG. 4C is a bottom view of the drying heater 40, and the FIG. 4D is a right side view of the drying heater 40.

Referring to FIG. 3, the drying heater 40 includes an upper case portion 40a and a lower case portion 40b. The upper case portion 40a houses a fan 46A mentioned later. The drying heater 40 is arranged such that the lower case portion 40b faces the package film 1 to be fed.

As illustrated in FIGS. 3 and 4A, the upper case portion 40a includes a top plate 41a, side plates 42a and 44a, a front plate 43a, and a back plate 45a. The top plate 41a has an intake hole 41A for inhaling air into the upper case portion 40a. The top plate 41a is composed of plural small openings.

As illustrated in FIGS. 3, 4B, 4C, 5, and 6, the lower case portion 40b includes a face plate 41b, side plates 42b and 44b, a front plate 43b, a back plate 45b, and a top plate 46b. The drying heater 40 is arranged such that the face plate 41b faces the package film 1 to be carried.

The face plate 41b has a blow hole 41B for blowing hot air to the package film 1. The blow hole 41B is composed of plural small openings as with the intake hole 41A. The blow hole 41B is provided in the face plate 41b facing the package film 1 to be fed, so that hot air can be blown to the package film 1.

The side plate 42b has a first exhaust hole 42B for blowing hot air in a direction receded from the package film 1. The first exhaust hole 42B is composed of openings provided at an even interval in a longitudinal direction of the drying heater 40 with each of the openings having a slit shape. Additionally, the side plate 44b also has a second exhaust hole 44B as with the first exhaust hole 42B, although they are not illustrated in FIGS. 3 and 4A to 4D. The first exhaust hole 42B and the second exhaust hole are arranged in such a manner that hot air blown from the first exhaust hole 42B and the second exhaust hole is exhausted in a direction substantially perpendicular to the package film 1. Therefore, hot air, which blown from the first exhaust hole 42B or from the second exhaust hole 44B, is not directly blown to the package film 1.

Next, a description will be given of an internal structure of the drying heater 40.

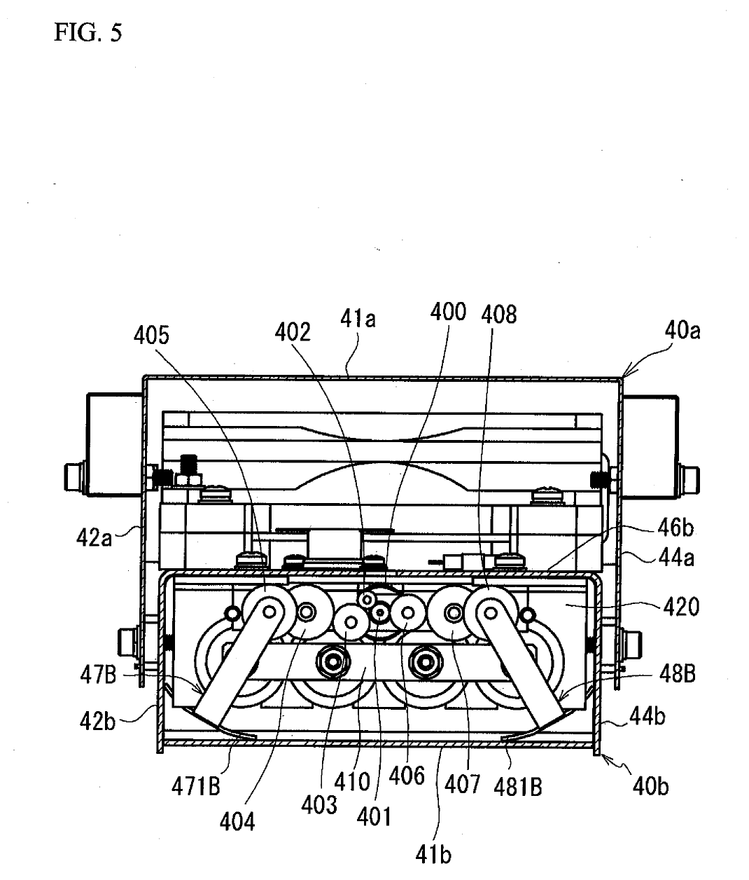

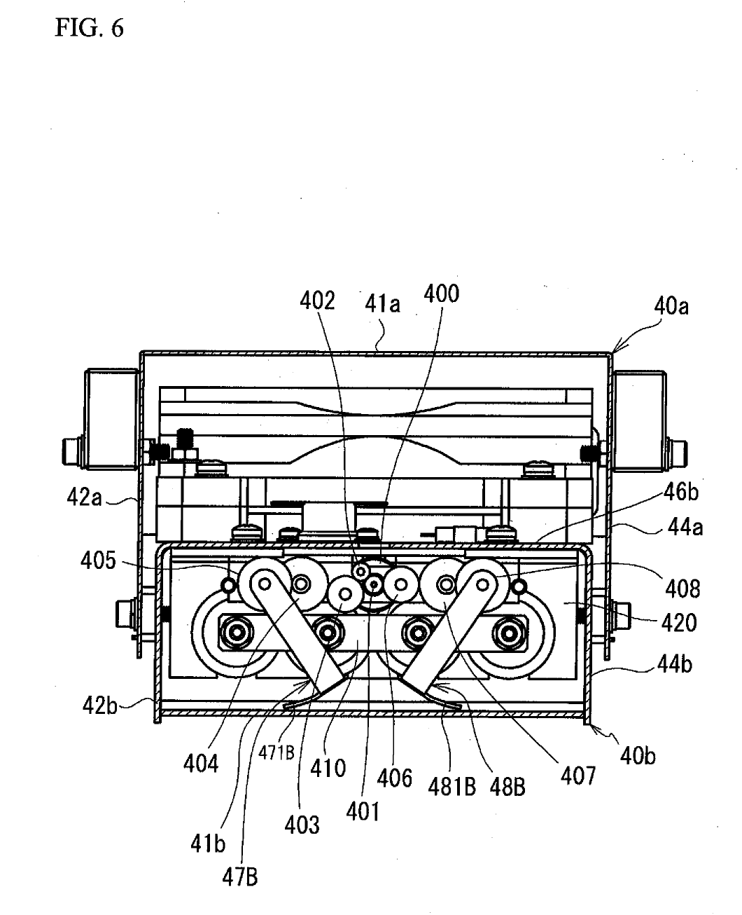

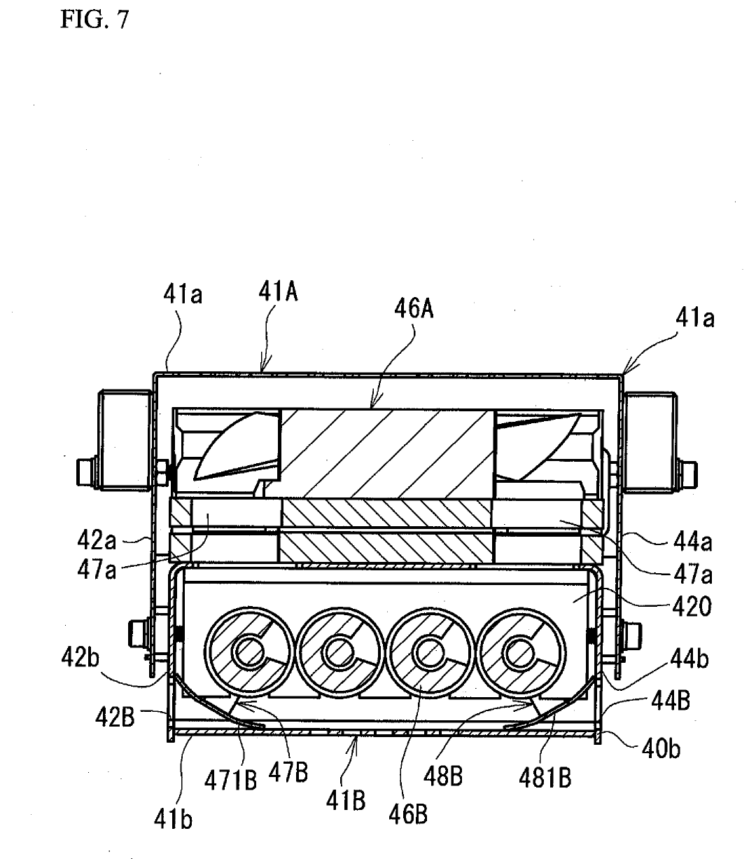

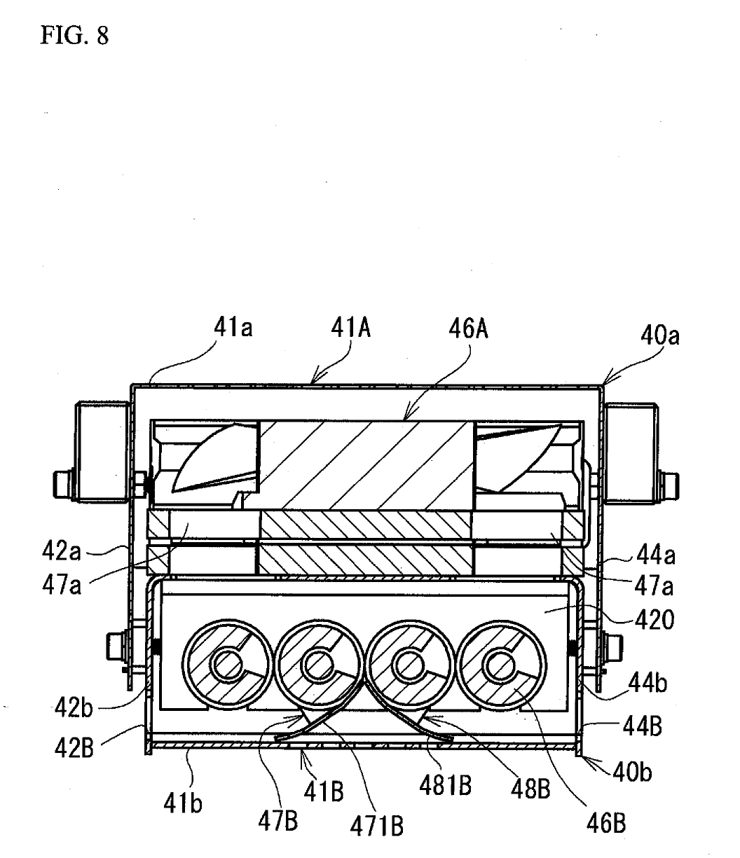

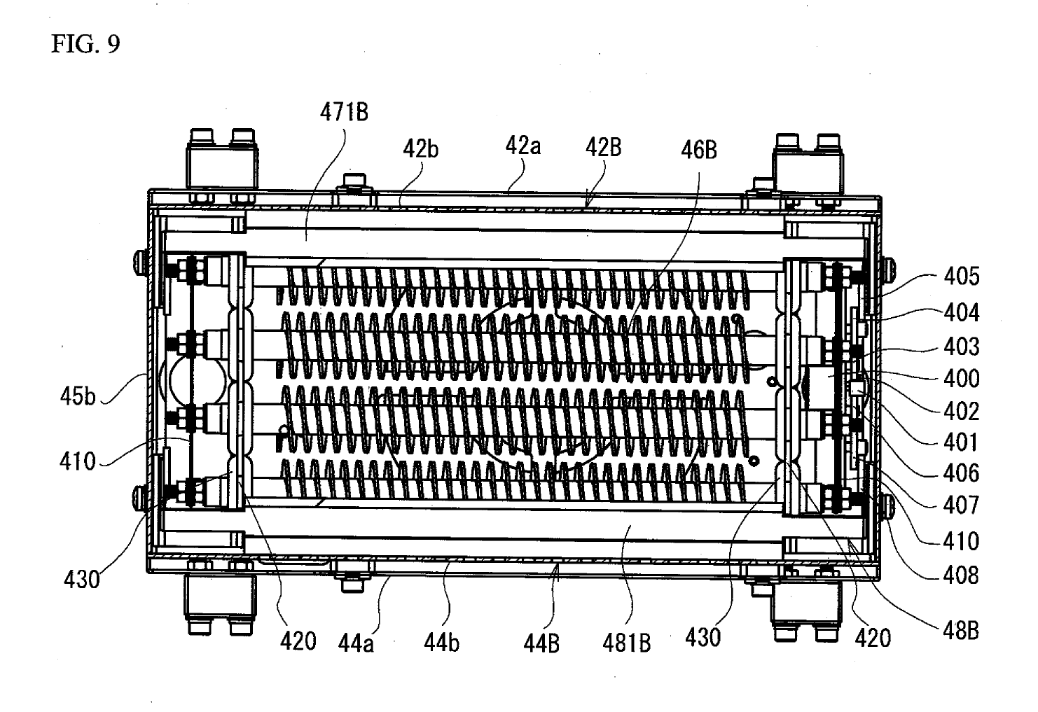

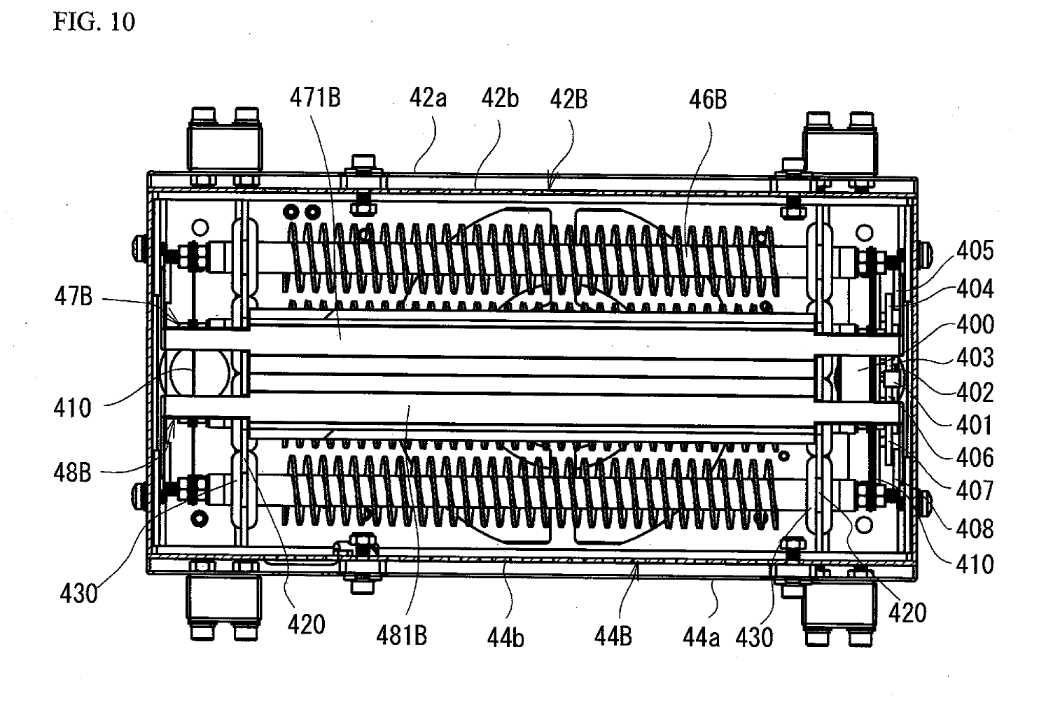

FIG. 5 is a cross-sectional view taken along A-A line in FIG. 4B, in a state in which the blow hole 41B is fully opened. FIG. 6 is a cross-sectional view taken along A-A line in FIG. 4B, in a state in which the blow hole 41B is fully closed. FIG. 7 is a cross-sectional view taken along B-B line in FIG. 4B, in the state in which the blow hole 41B is fully opened. Additionally, FIG. 8 is a cross-sectional view taken along B-B line in FIG. 4B, in the state in which the blow hole 41B is fully closed. FIG. 9 is a cross-sectional view taken along C-C line in FIG. 4B, in the state in which the blow hole 41B is fully opened. FIG. 10 is a cross-sectional view taken along C-C line in FIG. 4B, in the state in which the blow hole 41B is fully closed.

Referring now to FIGS. 5 to 8, within the lower case portion 40b, a heater portion 46B, a first opening and closing member 47B, a second opening and closing member 48B, a stepping motor 400, gears 401 to 408, electrodes 410, heater fixing plates 420, and the like are arranged.

As illustrated in FIGS. 9 and 10, the heater portion 46B has a rod shape with fins. Four heater portion 46B are arranged side by side and are extended in the longitudinal direction of the lower case portion 40b. The heater portion 46B is coated with an insulating layer. The heater portion 46B has the fins for increasing an area of heat release and increasing heat transfer efficiency at predetermined ranges except the proximities of the both ends of the heater portion 46B. Each end of the heater portion 46B is connected with the electrodes 410, thereby applying the current in the heater portion 46B. Application of the current causes the heater portion 46B to heat an air inhaled via the intake hole 41A.

The heater fixing plates 420 are attached to the top plate 46b. Heater fixing members 430 are attached to the heater fixing plates 420. The heater fixing member 430 is made of a elastic member such as a rubber. The heater fixing member 430 has a hole at its center portion, and the diameter of the hole is slightly smaller than that of the rod-shaped portion, except of the fins of the heater portion 46B. The end of the heater portion 46B is inserted into the hole, and then the diameter of the hole is spread according to the diameter of the end of the heater portion 46B. Therefore, the inner periphery of the hole provided in the heater fixing member 430 is brought into fit with the heater portion 46B by an elastic force. Since the heater fixing plates 420 are provided in the proximity of the both ends of the heater portion 46B, when the heater portion 46B is inserted into the heater fixing member 430, the both ends of the heater portion 46B are supported by the heater fixing plates 420.

In this manner, the heater portion 46B is attached to the lower case portion 40b. The position of the heater portion 46B is maintained by only the pressure contact force, which caused by the elastic deformation generated by inserting the heater portion 46B into the heater fixing member 430. Such a configuration absorbs the deformation of the heater portion 46B caused by the elasticity of the heater fixing member 430, even when the heater portion 46B is heated and thermally expanded. Therefore, the breakage caused by a heat stress is prevented.

The first and second opening and closing members 47B and 48B function as a blowing amount changing portion that changes the blowing amount of hot air blown to the package film 1. The first and second opening and closing members 47B and 48B further function change the opening rates of a blow hole 41B, the first exhaust hole 42B, and the second exhaust hole 44B, as will be mentioned below.

The first and second opening and closing members 47B and 48B have ends attached to the gears 405 and 408, respectively. The predetermined rotations of the gears 405 and 408 respectively swing the first and second opening and closing members 47B and 48B in the predetermined ranges. The drive power of the stepping motor 400, which is arranged at an center portion of the lower case portion 40b, is transmitted to the gears 405 and 408 via the gears 401 to 404 and the gears 406 to 408, respectively. The gear 401 is press fitted onto a rotational shaft of the stepping motor 400. The gear 401 transmits the drive power of the stepping motor 400 to the gears 402 and 406. The gear 402 transmits the drive force to the gear 403. The gear 403 transmits the drive force to the gear 404. The gear 404 transmits the drive force to the gear 405. Similarly, the gear 406 transmits the drive power to the gear 407, and the gear 407 transmits the drive force to the gear 408.

Additionally, the first and second opening and closing members 47B and 48B swing toward and away from each other by the rotation of the stepping motor 400.

The stepping motor 400 rotates in a predetermined range in response to the instruction outputted from the controller unit 64. The controller unit 64 controls the blowing amount of hot air to the package film 1 by controlling stop positions of the first and second opening and closing members 47B and 48B.

The first and second opening and closing members 47B and 48B have one ends attached to the gears 405 and 408, respectively. The first and second opening and closing members 47B and 48B have the other ends attached to opening and closing plates 471B and 481B, respectively. The opening and closing plates 471B and 481B each have a concave surface shape with respect to each one end. The opening and closing plates 471B and 481B open and close the blow hole 41B, the first exhaust hole 42B and the second exhaust hole 44B mentioned below.

Referring to FIGS. 7 and 8, the fan 46A is installed into the upper case portion 40a. The fan 46A functions as air blow portion. Air flows into the upper case portion 40a via the intake hole 41A by rotating the fan 46A. The inflowing air passes through ducts 47a which communicate the upper case portion 40a with the lower case portion 40b. Then, the inflowing air is blown to the heater portion 46B. The air is blown to the heater portion 46B and is heated to be hot. This hot air is exhausted via the blow hole 41B and/or the first exhaust hole 42B, and the second exhaust hole 44B, in response to positions of the first and second opening and closing members 47B and 48B.

As illustrated in FIG. 7, the opening and closing plates 471B and 481B allow the first exhaust hole 42B and the second exhaust hole 44B to be fully closed states (opening rate of 0 percent), when the blow hole 41B is allowed to be a fully open state (opening rate of 100 percent). Further, as shown in FIG. 8, the opening and closing plates 471B and 481B allow the first and second exhaust holes 428 and 44B to be fully open states, when the blow hole 41B is allowed to be a fully closed state. As illustrated in FIG. 10, the opening and closing plates 471B and 481B are brought into partially contact with each other, so that the blow hole 41B is closed.

In this manner, the opening and closing plates 471B and 481B open and close the blow hole 41B, the first exhaust hole 42B and the second exhaust hole 44B such that the opening rate of the blow hole 41B, and the opening rates of the first and second exhaust holes 42B and 44B are opposed to each other. That is, the first and second opening and closing members 47B and 48B function as opening and closing the first and second exhaust holes 42B and 44B in addition to opening and closing the blow hole 41B. As above mentioned, because the first and second opening and closing members 47B and 48B function as opening and closing the two openings, the number of the parts can be decreased.

The gear 408 is provided with a slit (not shown). A transmission sensor (not shown) is arranged to face the slit. When detecting that the second opening and closing member 48B is positioned as shown in FIG. 5, and the transmission sensor outputs a signal to the controller unit 64. The controller unit 64 sets the position as shown in FIG. 5 as an original position. As the position, as shown in FIG. 5, of the second opening and closing member 48B is set as the original position, the original position of the first opening and closing member 47B also is also set. When the stepping motor 400 rotates counterclockwise by predetermined pulses in response to the instruction outputted from the controller unit 64, the first and second opening and closing members 47B and 48B move closer to each other. Additionally, the gear provided with the slit is not limited to the gear 408, and any gear may be provided with the slit. Further, the first and second opening and closing members 47B and 48B may be directly detected.

In addition, the controller unit 64 allows the first and second opening and closing members 47B and 48B to stop between the positions shown in FIGS. 5 and 6 by controlling the number of the pluses applied to the stepping motor 400. This allows setting of the opening rate of the blow hole 41B and the opening rate of the first exhaust hole 42B and the second exhaust hole 44B, arbitrarily.

Next, a description will be given of the product data and the blowing amount setting data.

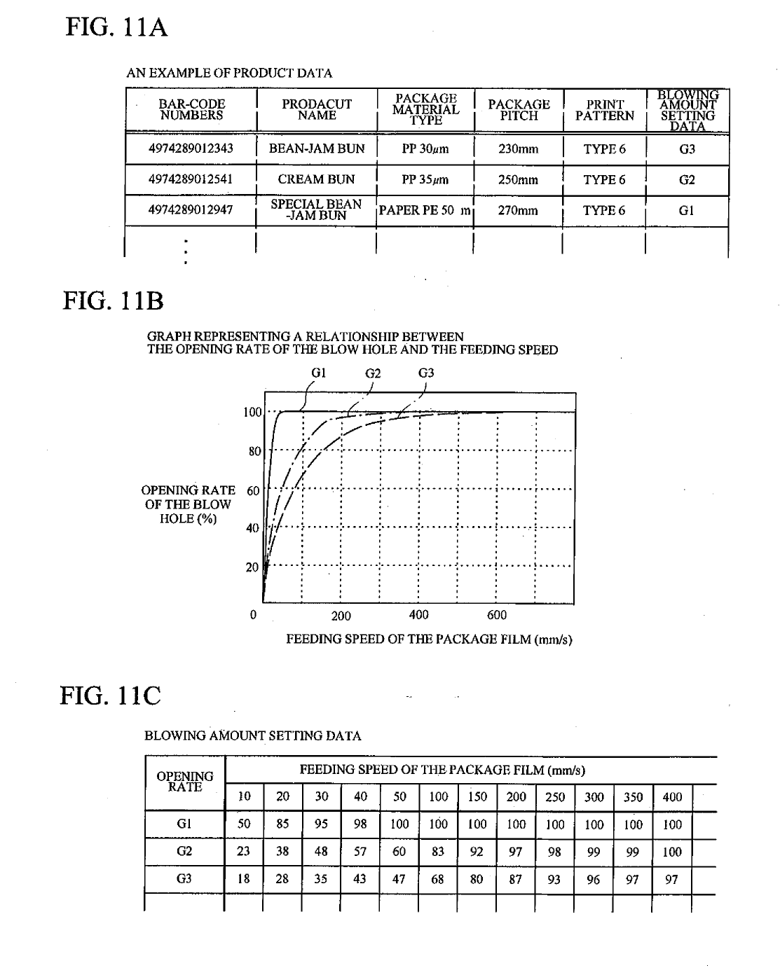

FIG. 11 is an illustrational view of a graph representing a relationship among the product data, the opening rate of the blow hole, and the blowing amount.

In a table of the product data, As illustrated in FIG. 11A the product names, the package material types, the package pitches, the print patterns, and the blowing amount setting data are associated with bar-code numbers. The product name represents a product packaged with the package film 1. The package material type represents a material and a thickness of the package film 1. The package pitch represents a size of the package film 1 corresponding to a product packaged with the package film 1. The print pattern represents a printed content. The print patterns are categorized by types. There several variations. For example, a printed content of the type 1 is “freshness date Dec. 10, 2006” or a printed content of the type 2 is “freshness date Dec. 10, 2006, manufacturers' unique mark ABC”. In addition, a user is able to freely set or change the print pattern by using the personal computer 80.

In this manner, the product data includes attribute information of the print medium. Further, the attribute of the print medium includes the package pitch and the print pattern in addition to the above package material type. The blowing amount setting data functions for specifying which blowing amount setting data is used from among the blowing amount setting data defining the opening rate relative to the feeding speed on the basis of each package material. This will be described below.

The package material type includes PP (polypropylene) paper PE (a paper having polyethylene lamination) or the like, whereas the package material type may include a composite material, such as PET (polyester), nylon, PVA (polyvinyl alcohol), polyvinyl chloride (PVC), cellophane (PT), and laminar film, and a evaporated material such as aluminum evaporation.

In a case where the print medium is a resin film, the surface to be printed of the print medium may be roughened by corona treatment, or white may be printed as a ground, in consideration of a compatibility between the print medium and the ink.

FIG. 11B illustrates a graph representing a relationship between the opening rate of the blow hole 41B and the feeding speed of the print medium. A curve G1, which is represented by a solid line on the relational graph, corresponds to paper PE of the package material type having a thickness of 50 μm, indicated by the product data. A curve G2, which is represented by a dashed line, corresponds to PP of the package material type having a thickness of 35 μm. A curve G3, which is represented by a broken line, corresponds to PP of the package material type having a thickness of 30 μm.

Referring now to FIG. 11B, the curves G1, G2, and G3 represent that the opening rate of the blow hole 41B is increased as the feeding speed is increased. This is because the controller unit 64 controls the first and second opening and closing members 47B and 48B in response to the feeding speed of the package film 1. As mentioned above, the first and second opening and closing members 47B and 48B are controlled in response to the feeding speed of the package film 1. Even when hot air is preset at a high temperature and the feeding speed is reduced by any cause, the package film 1 is prevented from being locally extended and winkled, and the dry property of the ink is improved by changing the blowing amount.

In particular, as described in the present embodiment, in a case where the printer according to the present invention is employed in the production line such as the packaging equipment, there may be cases where a large amount of products need to be produced for a shorter period than usual. Even in such a case, the temperature of the drying heater 40 is set to be higher temperature than the normal temperature according to the increased feeding speed. This improves the dry property of the ink and the productivity of the product.

The blowing amount setting data is indicated by a table representing such a relationship between the opening rate of the blow hole 41B and the blowing amount, the table having a lateral axis representing the feeding speed of the print medium and a longitudinal axis representing the opening rate of the blow hole 41B. As an example of the blowing amount setting data is illustrated in FIG. 11C.

Further, as illustrated in FIG. 11B, as compared with the curves G2 and G3, the curve G1 represents that the opening rate of the blow hole 41B is substantially kept at 100 percent in almost ranges of feeding speeds, even when the feeding speed of the package film 1 is slow. This is because the heat resistance of the package type corresponding to the curve G1 is higher than those of the package types corresponding to the curves G2 and G3. Even when the opening rate of the blow hole 41B is increased, there will be less influence. On the other hand, the curve G3 represents that the opening rate of the blow hole 41B is suppressed to become small, even when the feeding speed of the package film 1 is fast, as compared with the curves G1 and G2. This is because the package type corresponding to the curve G3 is weaker against heat than those correspond to the curves G1 and G2, and it is needed to suppress the opening rate of the blow hole 41B.

As mentioned above, the controller unit 64 controls the first and second opening and closing members 47B and 48B in response to the feeding speed and the attribute of the package film 1. This precisely changes the blowing amount of hot air. That is, even when the feeding speeds of the package film 1 are almost the same, the heat resistances are different due to the material of the package film 1. For this reason, in consideration of attribute of the printed media, the package film 1 is prevented from being extended and winkled, and the drying property of the ink can be improved.

As mentioned above, the first and second opening and closing members 47B and 48B change the opening rates of the blow hole 41B, the first and second exhaust holes 42B and 44B, so that the blowing amount of hot air blown to the package film 1 is changed. Since the drying heater 40 has the first and second exhaust holes 42B and 44B, an excessive increase of temperature in the drying heater 40, caused by retaining hot air in the drying heater 40 when the opening rate of the intake hole 41A is reduced, can be prevented. Therefore, the load on the drying heater 40 is suppressed. For example, a bearing for the rotation of the fan 46A can be prevented from being seizing.

Additionally, the first and second opening and closing members 47B and 48B change the opening rates of the blow hole 41B, and the first and second exhaust holes 42B and 44B such that the opening rate of the blow hole 41B and these of the first and second exhaust holes 42B and 44B are opposed to each other, thereby changing the blowing amount of hot air blown to the package film 1. With this configuration, the opening rate of the blow hole 41B, and these of the first and second exhaust holes 42B and 44B are opposed to each other, thereby changing the blowing amount of hot air blown to the package film 1 without greatly influencing the blowing velocity of hot air blown to the package film 1.

For example, when the opening rate of the blow hole 41B and these of the first and second exhaust holes 42B and 44B are both increased, the blowing velocity of hot air blown from the blow hole 41B may be excessively weakened and the ink may be hardly dried. Moreover, both of the opening rate of the blow hole 41B and those of the first and second exhaust holes 42B and 44B are decreased, the blowing velocity of hot air blown form the blow hole 41B may be excessively strengthened and the package film 1 may be partially extended and winkled. When the opening rate of the blow hole 41B is decreased or increased with the opening rates of the first and second exhaust holes 42B and 44B being kept constant, the same problem may arise. The opening rate of the blow hole 41B and those of the first and second exhaust holes 42B and 44B are changed such that the opening rate of the blow hole 41B and those of the first and second exhaust holes 42B and 44B are opposed to each other, thereby resolving these problems.

### Second Embodiment

Next, a description will be given of a case where something is printed on a box by using a printer according to the present invention.

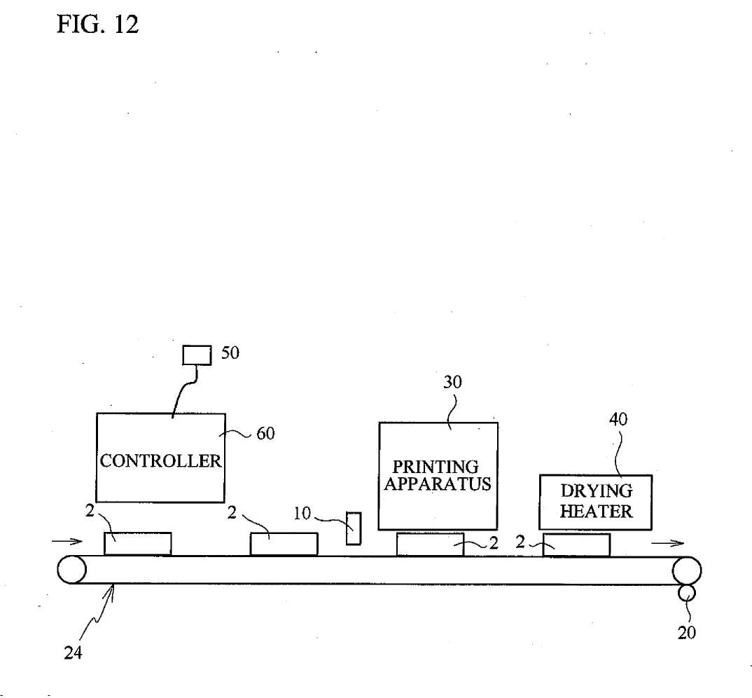

FIG. 12 is an explanatory view of the case where something is printed on a box by using a printer. Additionally, the same components as those of the first embodiment are denoted by the same reference numerals as those of the first embodiment in order to avoid a duplicated explanation.

A box 2, as a printed medium, is fed in a given direction by the driving roller 22. The timing sensor 10, the printing apparatus 30 and the drying heater 40, facing the box 2, are arranged in this order from an upstream side to a downstream side. The box 2 fed by the driving roller 22 is read out by the timing sensor 10 to measure the print timing. The encoder 20 is arranged to be rotated in accordance with the movement of the belt conveyor 23. The speed of the belt conveyor 23 is detected by the encoder 20, thereby detecting the feeding speed of the box 2. The printing apparatus 30 prints on the box 2 at a given timing on the basis of the print timing and the feeding speed detected by the encoder 20. The printed box 2 is dried by the drying heater 40.

The feeding speed of the belt conveyor 23 is varied depending on the whole state of the production line. Therefore, the drying heater 40 controls the flowing amount to the box 2 in response to the feeding speed of the box 2, thereby assuring the same effect of the first embodiment.

While the exemplary embodiments of the present invention have been illustrated in detail, the present invention is not limited to the above-mentioned embodiments, and other embodiments, variations and modifications may be made without departing from the scope of the present invention.

In the first embodiment, the print medium has an example of a package film. However, the printed medium may be paper or the like.

In the first embodiment, the drying heater 40 changes the blowing amount of hot air blown to the package film 1 according to the feeding speed and the type of the package film 1. The present invention is not limited to this configuration. For example, the blowing amount of hot air may be changed in consideration of the package pitches or the print patterns.

In the above embodiments, the first and second opening and closing members 47B and 48B open and close the blow hole 41B, and the first and second exhaust holes 42B and 44B. However, the present invention is not limited to this configuration. A blow hole opening and closing member for opening and closing only the blow hole, and an exhaust hole opening and closing member for opening and closing only the exhaust hole, may be separately provided. In this configuration, by opening and closing at least one of the blow hole and the exhaust hole, the blowing amount of hot air blown to the print medium may be changed.

The above embodiments have been described of hot air is blown to the print medium so as to dry the ink applied on the print medium. The present invention is not limited to this configuration. For example, not only hot air but also dehumidified and heated air may be blown.

Finally, several aspects of the present invention are summarized as follows.

According to an aspect of the present invention, there is provided a printer including: a print head for ejecting ink on a print medium; a drying portion for blowing hot air to the printed print medium so as to expedite drying of the ink applied on the printed print medium, the drying portion including a blowing amount changing portion changeable a blowing amount of the hot air blown to the print medium; a detecting portion for detecting a feeding speed of the print medium; and a controller for controlling the blowing amount changing portion in response to the feeding speed of the print medium detected by the detecting portion.

With such a configuration, since the blowing amount changing portion can be controlled in response to the feeding speed of the print medium, the temperature of the hot air is set high beforehand and the blowing amount is changed, even when the feeding speed of the print medium is reduced by any cause, the print medium is prevented from being wrinkled and extended, and the drying property of the ink is improved.

In the above configuration, the controller may change a control condition in response to an attribute of the print medium. With such a configuration, the blowing amount of hot air can be finely changed. Under the condition in that the feeding speeds are identical, the heat resistance of the print medium is deferent according to the material of the print medium. Therefore, for example, in consideration of the attribution of the print medium, the print medium is prevented from being wrinkled and extended, and the drying property of the ink is improved.

In the above configuration, the drying portion may include: a blow hole from which the hot air is blown toward the print medium; and an exhaust hole from which the hot air is blown away from the print medium, and the blowing amount changing portion may change the blowing amount of hot air blown toward the print medium by changing the opening rate of at least one of the blow hole and the exhaust hole.

With such a configuration, since the blow hole of the opening rate is changed and the drying portion includes the exhaust hole, the hot air is prevented from being retained in the drying portion when the opening rate of the exhaust hole is reduced, the interior of the drying portion is prevented from being excessively heated. Therefore, the burden applied to the drying portion is prevented.

Further, the opening rate of at least one of the blow hole and the exhaust hole can be changed, thereby changing the blowing amount of hot air blown to the print medium.

Furthermore, with such a configuration, when the print is turned off, the hot air can be exhausted via the exhaust hole even if the hot air is rarely exhausted between the printed medium and the drying heater because these are arranged closer to each other. Therefore, the temperature of the drying portion can be rapidly reduced, shorting a period between the time when the work is finished and the time when the power is turned off.

In the above configuration, the blowing amount changing portion may change the opening rates of the blow hole and the exhaust hole such that the opening rates of the blow hole and the exhaust hole become opposed to each other, so that the blowing amount changing portion changes the blowing amount of hot air blown to the print medium.

With such a configuration, by changing the opening rates of the blow hole and the exhaust hole such that the opening rates of the blow hole and the exhaust hole become opposed to each other, the blowing amount of hot air blown to the print medium can be changed without greatly influencing the blowing velocity of hot air to be blown to the print medium. For example, in a different configuration, the opening rate of the blow hole and that of the exhaust hole are changed to be greater, the blowing velocity of hot air blown from the blow hole may be too weakened, and the ink may be hardly dried. Additionally, the opening rates of the blow hole and that of the exhaust hole are changed to be smaller, the blowing velocity of hot air blown from the blow hole may be too strengthened, and the print medium may be partially winkled and extend. When the opening rate of the blow hole is reduced or increased with the opening rate of the exhaust hole being kept constant, the same problem mentioned above may arise. By changing the opening rate of the blow hole and that of the exhaust hole such that these are opposed to each other, this problem may be resolved.

In the above configuration, the blowing amount changing portion may include: a blow hole opening and closing member; and an exhaust hole opening and closing member respectively changing the opening rates of the blow hole and the exhaust hole.

With such a configuration, since each of the opening rate of the blow hole and that of the exhaust hole can be changed, the blowing amount of hot air blown to the print medium and the blowing velocity of the hot air can be finely adjusted.

In the above configuration, the blow hole opening and closing portion and the exhaust hole opening and closing portion may be united into a single member. With such a configuration, the number of the parts can be reduced.

What is claimed is:

1. A printer comprising:
a print head for ejecting ink on a print medium;
a drying portion for blowing hot air to the printed print medium so as to expedite drying of the ink applied on the printed print medium, the drying portion including a blowing amount changing portion changeable a blowing amount of the hot air blown to the print medium;
a detecting portion for detecting a feeding speed of the print medium; and
a controller unit for controlling the blowing amount changing portion in response to the feeding speed of the print medium detected by the detecting portion.

2. The printer of claim 1, wherein the controller unit changes a control condition in response to an attribute of the print medium.

3. The printer of claim 1, wherein the drying portion includes:
a blow hole from which the hot air is blown toward the print medium; and
an exhaust hole from which the hot air is blown away from the print medium, and
wherein the blowing amount changing portion changes the blowing amount of the hot air blown toward the print medium by changing the opening rate of at least one of the blow hole and the exhaust hole.

4. The printer of claim 3, wherein the blowing amount changing portion changes the opening rates of the blow hole and the exhaust hole such that the opening rates of the blow hole and the exhaust hole become opposed to each other, so that the blowing amount changing portion changes the blowing amount of the hot air blown to the print medium.

5. The printer of claim 3, wherein the blowing amount changing portion includes:
a blow hole opening and closing member; and
an exhaust hole opening and closing member respectively changing the opening rates of the blow hole and the exhaust hole.

6. The printer of claim 5, wherein the blow hole opening and closing portion and the exhaust hole opening and closing portion are united into a single member.
